(19) United States
(12) Patent Application Publication
(10) Pub. No.: US 2016/0301176 A1
(43) Pub. Date: Oct. 13, 2016

(54) BATTERY CLIP CONNECTION

(71) Applicant: Battery Clip-USB, Inc., The Woodlands, TX (US)

(72) Inventor: Thomas Richard Mathews, The Woodlands, TX (US)

(21) Appl. No.: 15/094,548

(22) Filed: Apr. 8, 2016

Related U.S. Application Data
(60) Provisional application No. 62/178,480, filed on Apr. 13, 2015.

(51) Int. Cl. H01R 43/26; B60L 11/18; H01R 11/28; H02J 7/00

(52) U.S. Cl. CPC H01R 43/26; H02J 7/007; H02J 7/0052; B60L 11/1818; H01R 11/282; H02J 2007/0062

(57) ABSTRACT

A battery clip connection having a first battery clip, a second battery clip, a housing, a USB connection disposed in the housing, and a wire connecting the first battery clip and the second battery clip to the housing. Also, a method of charging a portable electric device, the method including removing a cover from a motive device and disclosing a power source, connecting a first battery clip of a battery clip connection to a first power of the power source. Further, connecting a second battery clip of the battery clip connection to a second post of the power source, extending a wire of the battery clip connection though the cover of the motive device, and exposing a housing having a USB connection outside the cover of the motive device. Further, attaching the portable electric device to the USB connection and providing power to the portable electric device.

### CROSS-REFERENCE TO RELATED APPLICATIONS

This application claims the benefit pursuant to 35 U.S.C. §119 of U.S. Provisional Application Ser. No. 62/178,480 flied Apr. 13, 2015. This application is incorporated by reference in its entirety.

### BACKGROUND OF THE INVENTION

Portable electric devices have become a way of life for most individuals. Most individuals carry on their person or use at least one portable electric device on a daily basis. Examples of electric portable devices include, for example, cellular phones, music playing device, video capturing devices, computing devices, speakers, global positioning system devices, as well as various other devices.

While the portable electric devices individuals use may have different uses and or purposes, most rely on rechargeable batteries. Rechargeable batteries include combinations of electrode and electrolyte materials such as, for example, lithium ion, lead-acid, nickel cadmium, nickel metal hydride, and lithium ion polymer. The rechargeable batteries are designed to be recharged many times over the life of the batteries, thereby giving them greater utility than conventional batteries, which are not designed to be recharged.

Rechargeable batteries may be configured to be recharged in a variety of ways including connecting the batteries directly or indirectly to alternating or direct current power sources. In many instances, the rechargeable batteries may be connected using a battery charger connected to an alternating current power source, such as a wall socket. In other instances, the rechargeable batteries may be connected directly or indirectly to a direct current power source, such as the 12-volt battery of a car or other direct current power source.

Many portable electric devices do not include a port that allows direct connection to a power source. As such, various types of connections may be used to connect portable electric devices to a power source. One such type of connection is a universal serial bus (“USB”) connection. In such applications, a USB connection may be established between the portable electric device and a power source, thereby allowing the portable electric device to charge. Using USB connections to charge portable electric devices allows the device to have a single connection that allows for charging, as well as uploading and downloading of media files, thereby allowing a single connection to provide multiple functions.

While portable electric devices include connections, such as USB connections that allow the devices to be recharged, not all power sources are readily configured to charge portable electric devices through such USB connections. Thus, there exists a continuing need for devices that allow portable electric devices to be attached to and recharged from various power sources such as, for example, portable power sources. Portable power sources may include power sources that are not conventionally used to recharged portable electric devices such as, for example, golf carts, boats, motorcycles, and other powered motive devices.

### BRIEF SUMMARY OF THE INVENTION

According to one aspect of one or more embodiments of the present invention, a battery clip connection having a first battery clip, a second battery clip, a housing, a USB connection disposed in the housing, and a wire connecting the first battery clip and the second battery clip to the housing.

According to one aspect of one or more embodiments of the present invention, a method of charging a portable electric device, the method including removing a cover from a motive device and disclosing a power source, connecting a first battery clip of a battery clip connection to a first power of the power source. Further, connecting a second battery clip of the battery clip connection to a second post of the power source, extending a wire of the battery clip connection though the cover of the motive device, and exposing a housing having a USB connection outside the cover of the motive device. Further, attaching the portable electric device to the USB connection and providing power to the portable electric device.

Other aspects of the present invention will be apparent from the following description and claims.

### BRIEF DESCRIPTION OF THE DRAWINGS

FIG. 1 is an isometric view of a battery clip connection according to embodiments of the present disclosure.

FIG. 2 is a top view of a battery connection in an open position according to embodiments of the present disclosure.

FIG. 3 is a top view of a battery clip connection in a closed position according to embodiments of the present disclosure.

FIG. 4 is an isometric view of a housing of a battery clip connection according to embodiments of the present disclosure.

FIG. 5 is a top view of a USB connection of a battery clip connection according to embodiments of the present disclosure.

FIG. 6 is a side view of a USB connection of a battery clip connection according to embodiments of the present disclosure.

FIG. 7 is an isometric view of a USB connection of a battery clip connection according to embodiments of the present disclosure.

FIG. 8 is an isometric view of a golf cart according to embodiments of the present disclosure.

FIG. 9 is an isometric view of a battery according to embodiments of the present disclosure.

FIG. 10 is an elevated side view of a golf cart battery compartment according to embodiments of the present disclosure.

FIG. 11 is an elevated side view of installing a battery clip connection to a battery of a golf cart according to embodiments of the present disclosure.

FIG. 12 is an elevated front side view of a battery clip connection installed in a golf cart according to embodiments of the present disclosure.

FIG. 13 is a top view of a battery clip connection installed in a golf cart and charging a cell phone according to embodiments of the present disclosure.

FIG. 14 is a side view of a battery clip connection having a mounting apparatus according to embodiments of the present disclosure

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

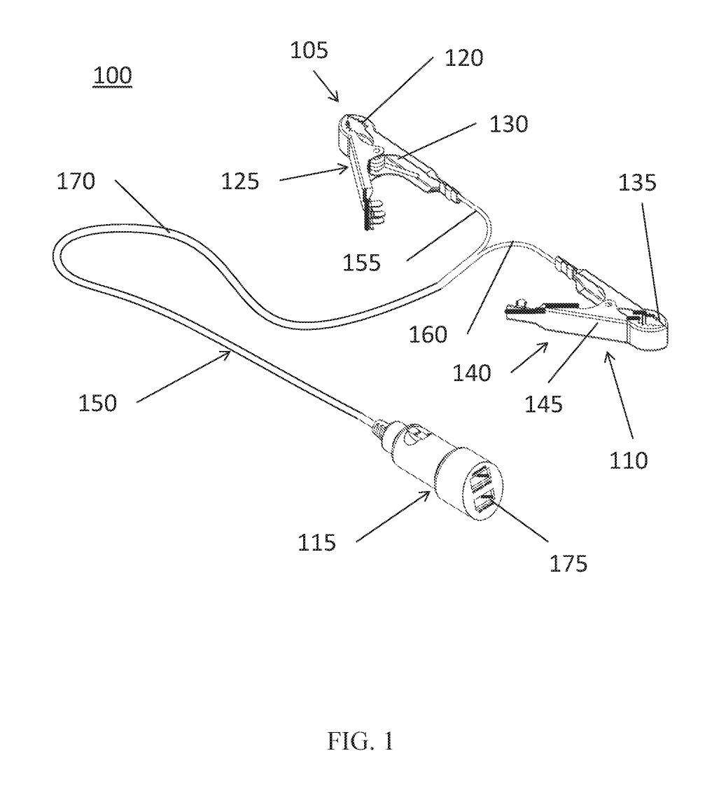

Referring to FIG. 1, an isometric view of a battery clip connection according to embodiments of the present invention is shown. In this embodiment, a battery clip connection 100 is shown having a first battery clip 105, a second battery clip 110, and a housing 115.

First battery clip 105 includes a terminal connection 120. Terminal connection 120 may be a crocodile clip, an alligator clip, a spring clip, a Kelvin clip, or any other type of mechanical clip that may be used to create a temporary connection to a power source, such as a battery. Terminal connection 120 may be formed of various metal and metal alloys such as copper and/or ferrous alloys. In one embodiment, terminal connection 120 may be formed from solid copper so as to provide low electrical resistance. First battery clip 105 may also include a handle portion 125. Handle portion 125 may be coated or surrounded in a layer of insulation 130. The insulated layer may prevent current from being transferred from terminal connection 120 to a user or other device. Examples of insulation 130 that may be used include Teflon®, alumina, polymer composites, such as fibre reinforced plastic, silicone rubber, ethylene propylene diene monomer rubber, and/or other materials that those of ordinary skill in the an would appreciate provide high resistivity.

In addition to first battery clip 105, battery clip connection 100 includes a second battery clip 110, Second battery clip 110 also includes a terminal connection 135. Terminal connection 135 may be a crocodile clip, an alligator clip, a spring clip, a Kelvin clip, or any other type of mechanical clip that may be used to create a temporary connection to a power source, such as a battery. Terminal connection 135 may he formed of various metal and metal alloys such as copper and/or ferrous alloys. In one embodiment, terminal connection 135 may be formed from solid copper so as to provide low electrical resistance. Second battery clip 105 may also include a handle portion 140. Handle portion 140 may be coated or surrounded in a layer of insulation 145. The insulated layer may prevent current from being transferred from terminal connection 135 to a user or other device. Examples of insulation 145 that may be used include Teflon®, alumina, polymer composites, such as fibre reinforced plastic, silicone rubber, ethylene propylene diene monomer rubber, and/or other materials that those of ordinary skill in the art would appreciate provide high resistivity.

First battery clip 105 and second battery clip 110 may be coded in order to inform a user whether the battery clip 105/110 should be connected to a positive or negative terminal connection (not shown) of a power source (not shown). In one embodiment, first battery clip 105 may be configured to be connected to a positive terminal of a power source and second battery clip 110 may be configured to be connected to a negative terminal of a power source. In such an embodiment, first battery clip 105 may be colored red, while second battery clip 110 may be colored black. In other embodiments, different color coating schemes, as well as other designations may be used to inform a user whether the battery clip 105/110 is configured to be connected to a positive or negative power source. Other methods of informing a user which polarity of a power source to connect battery clips 105/110 to include designations such as “+” to indicate a positive connection and “−” to indicate a negative connection. Those of ordinary skill in the art will appreciate that other forms of informing users of the polarity of the connection may also be used.

First battery clip 105 and second battery clip 110 are connected to a wire 150. The wire 150 may consist of two separate wires 155 and 160, whereby a first separate wire 155 is connected directly or indirectly to first battery clip 105 and a second separate wire 160 is connected directed or indirectly to second battery clip 110. In this embodiment, first and second separate wires 155/160 join into a single wire housing 165. However, in other embodiment, first and second wires 155/160 may not join into single wire housing 165, instead remaining independent to their terminal connection, which will be discussed below.

Wire 150, including first and second separate wires 155/160 may be formed from various metals and metal alloys such as, for example, copper and/or ferrous alloys. In one embodiment, wire 150 may be formed substantially from copper no as to provide low resistance. Wire 150 and/or first and second wires 155/160 may also be coated in an insulation layer 170. Insulation layer may be formed from any high resistance material such as, for example, include Teflon, alumina, polymer composites, such as fibre reinforced plastic, silicone rubber, ethylene propylene diene monomer rubber.

Wire 150 may be of varying lengths according to the requirements of a charging operation. For example, in one embodiment, wire 150 may be approximately 120 inches in length, while in other embodiments, wire may be between 12.0 and 24.0 inches in length, and in still other embodiments, wire may be greater than 24.0 inches in length. In certain embodiments, wire 150 is at least 24.0 inches in length in order to provide along enough connection to allow battery clip connection 100 to connect to a portable electric device (not shown) and a power source (not shown and still allow the user to access the device.

Wire 150 may be of varying diameters. In one embodiment, wire 150 may be 6 gauge, 8 gauge, 10 gauge, 12 gauge, 14 gauge, 16 gauge, 18 gauge, 20 gauge, or smaller, depending on the requirements of the charging operation. Those of ordinary skill in the art will appreciate that the gauge of wire 150 may vary depending on the amount of current supplied to wire 150, as well as the length of wire 150.

Battery clip connection 100 also includes housing 115. Housing 115 may be formed from various materials such as metals, plastics, polymer composite, and the like. In one embodiment, housing 115 may be formed from a plastic or polymer composite that is substantially environmentally resistant. In such an embodiment, housing 115 may provide a weather resisting housing 115 that prevents the influx of water into housing 115.

Housing 115 may include one or more electric connections 175 that allow portable electric devices (not shown) to be connected thereto. In the embodiment shown in FIG. 1, housing 115 includes two electric connections 175. The electric connections 175 in this embodiment are USB connections, and thereby allow at least two portable electric devices to be connected to housing 115. In other embodiments, housing 115 may include one electric connection 175 or more than two electric connections 175. In still other embodiments, one electric connection 175 may be connected to an external adapter (not shown) that splits the electric connection 175 into more than one electric connection 175, thereby allowing multiple devices to be connected to housing 115 through a single housing electric connection 175.

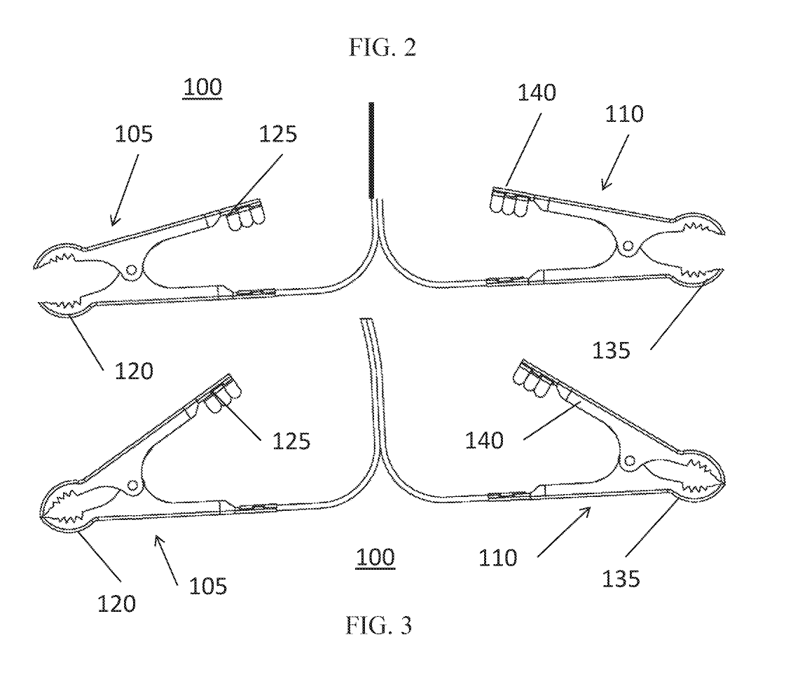

Referring to FIG. 2, a top view of a battery clip connection in an open position according to embodiments of the present disclosure is shown. As illustrated, handle portion 125 for first battery clip 105 is shown in a depressed position. Depression of handle 125 of first battery clip 105 opens terminal connection 120, In an open position, terminal connection 120 may be connected to a power source, such as a battery, thereby providing power to battery clip connection 100.

Similarly, handle portion 140 of second battery clip 110 is shown in a depressed position. Depression of handle 140 of second battery clip 110 opens terminal connection 135. In the open position, terminal connection 140 may be connected to a power source, such as a battery, thereby providing power to battery clip connection 100.

By decreasing pressure applied to handle portions 125/140, the corresponding terminal connections 120/135 may return to their unbiased state, i.e., into a closed position. In other embodiments, rather than have terminal connections 120/135 biased into a closed position, terminal connections 120/135 may include screw actuated. connections, snap-fit connections, or other mechanical connections that allow terminal connections 120/135 to be opened and closed.

Referring to FIG. 3, a top view of a battery clip connection in a closed position according to embodiments of the present disclosure is shown. As illustrated, handle portion 125 for first battery clip 105 is shown in a closed position. In an unbiased condition handle 125 of first batter clip 105 causes terminal connection 120 to he closed. In the closed position, terminal connection 120 may be connected to a power source, such as around the terminal of a battery, thereby providing power to battery clip connection 100.

Similarly, handle portion 140 of second battery clip 110 is shown in a closed position. In an unbiased condition handle 140 of second battery clip 110 closes terminal connection 135. In the closed position, terminal connection 140 may be connected to a power source, such as around the terminal of a battery, thereby providing power to battery clip connection 100.

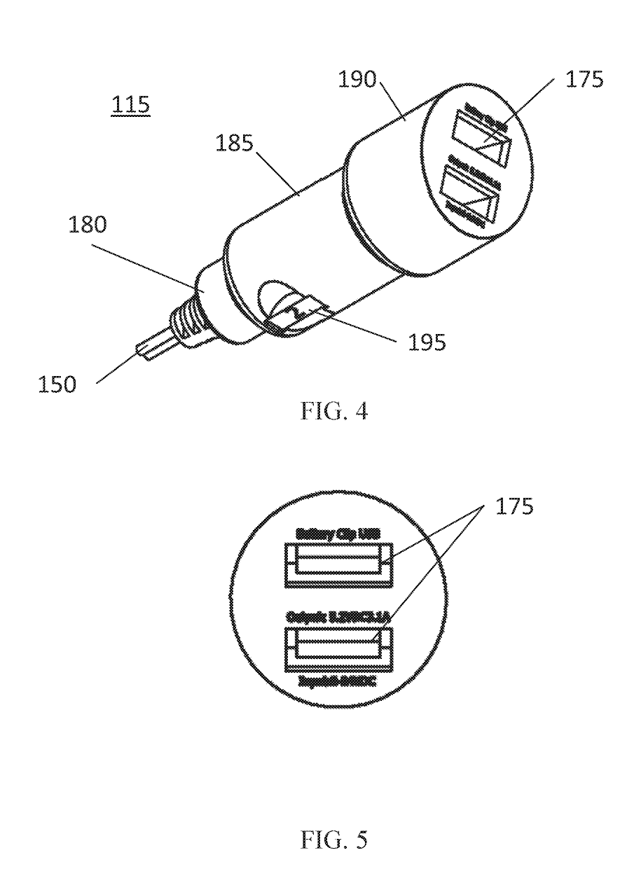

Referring to FIG. 4, an isometric view of a housing of a battery clip connection according to embodiments of the present disclosure is shown. In this embodiment, housing 115 is illustrated having a receiving portion 180 configured to receive wire 150 from the battery clips (105/110 of FIG. 1). In addition to receiving portion 180, housing 115 includes a main body 185, and a connector portion 190.

Main body 185 may house various components, such as circuit boards (not shown), power regulators (not shown), fuses (not shown), and the like. Main body 185 may also include signal indicators 195. Signal indicators 195 may include lights or other displays that provide information to a user. In one embodiment, signal indicator 19 may be alight emitting diode (“LED”) that when illuminated informs a user the device is charging an electric portable device (not shown). In other embodiments, signal indicator 190 may include an alphanumeric display that provides a user information such as the charging state of a device, the amount of charge remaining, the time remaining on the charge cycle, the number of devices that are charging, etc.

In certain embodiments, signal indicator 195 may also serve as a switch. In such an embodiment, the user may depress signal indicator 195, thereby turning battery clip connection 100 either on or off. Those of ordinary skill in the art will appreciate that in certain embodiments a switch may be used that is not a signal indicator 195, which also allows battery clip connection 195 to be modulated between an on or off condition.

Housing 115 also includes a connector portion 190. Connector portion 190 may he connected to main body 185 through a screw-fit connection, through a snap connection, or though other mechanical connections as will be appreciated by those of ordinary skill in the art.

Connector portion 190 also includes two electric connections 175. In this embodiment, electric connections 175 are USB connections. In other embodiments, electric connections 175 may be any other type of connection that are capable of providing power to electric portable devices (not shown).

Referring to FIG. 5, a top view of a USB connection of a battery clip connection according to embodiments of the present disclosure is shown. As explained above, in this embodiment battery clip connection includes two electric connections 175, which are USB connections. Depending on the requirements of the charging operation the amount of power provided may vary. In one embodiment, electric connection 175 may provide 500 milliamps of power at 5 volts, while in other embodiments, electric connection 175 may provide 900 milliamps of power at 5 volts, In still other embodiments, electric connection may provide power at 12 volts, 19 volts, 24 volts, 25 volts, or other voltages. Electric connections may be capable of operating at up to 6 amps, including providing a sustainable current of 1.5 amps at 5 volts or 12 volts or 2.3 amps at 24 volts. In still other embodiments, electric connections 175 may be capable of providing power at custom amp and voltage specifications. For example, in certain embodiments, electric connections 175 may provide higher currents, such as up to 2 amps at 5 volts or 5 amps at 12 volts or 20 volts.

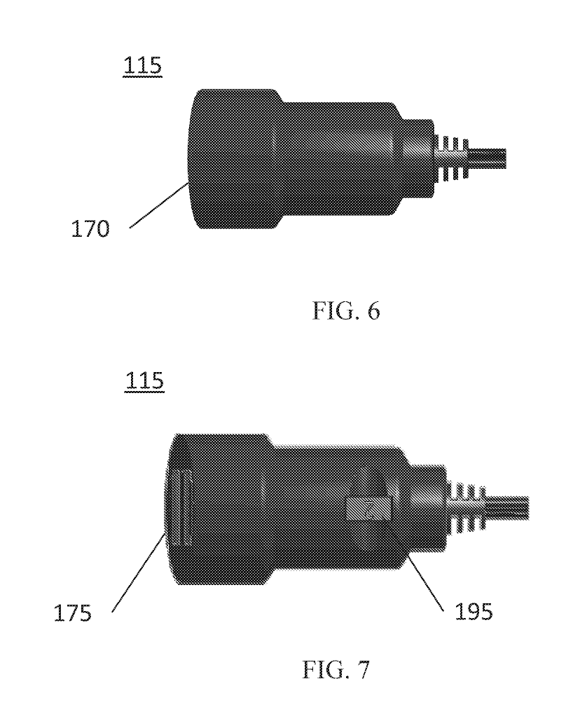

Referring to FIG. 6, a side view of a USB connection of a battery clip connection according to embodiments of the present disclosure is shown. As illustrated, FIG. 6 shows a housing 115 as a unibody construction. In such an embodiment, rather than have two or more separate components. housing 115 is formed as unibody construction. Such unibody construction may provide a substantially environmentally resistant housing 115, thereby preventing water or other environmental conditions, such as dust, dirt, and the like from entering housing 115. Unibody construction of housing 115 may be formed by plastic extrusion, pultrusion, plastic injection molding, or other forms of unibody construction as will be appreciated by those of ordinary skill in the art.

In certain embodiments. housing 115 also includes an environmentally and/or water proof cap 170. Water proof cap 170 map fit over a portion of housing 115, thereby preventing water from entering housing 115 though electric connections (175 of FIG. 4).

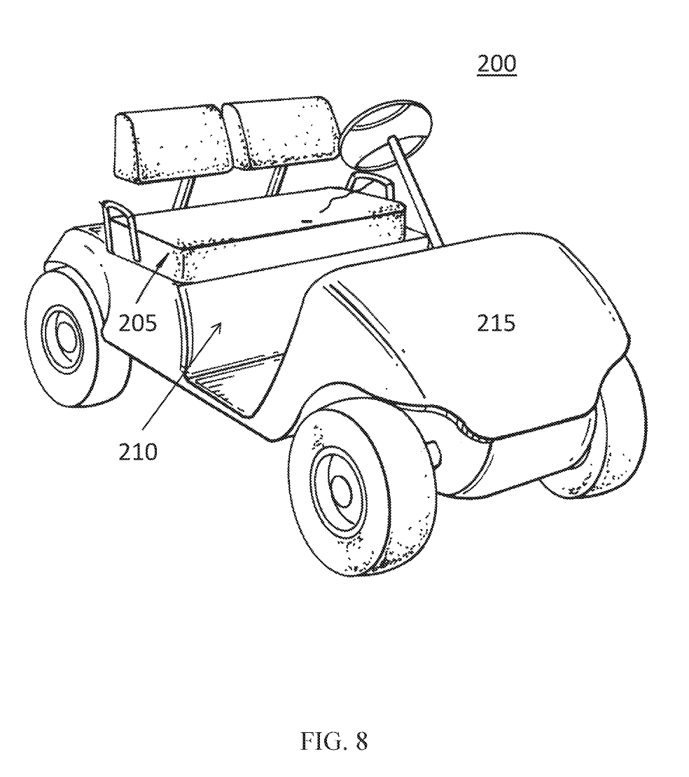

Referring to FIG. 7, an isometric view of a USB connection of a battery clip connection according to embodiments of the present disclosure is shown. As illustrated, FIG. 7 shows a housing 115 as a unibody construction. Housing 115 includes a signal indicator 195, and multiple electric connections 175, as discussed above.

Referring to FIG. 8, an isometric view of a golf cart according to embodiments of the present disclosure is shown. In one embodiment, battery clip connection (100 of FIG. 1) may be attached to a power source, such as a battery (not shown) in a motive device, such as a golf cart 200. Golf cart 200 includes a seat 205 and a battery compartment 210. In typical golf cart 200 design, the batteries are disposed in battery compartment 210, which is located under seat 205. The seat 205 may then be lifted up in order to expose the batteries. While typical golf carts 200 include a battery compartment 210 located under seat 205, in other embodiments battery compartment 210, and thus batteries, may be located in other portions of golf cart 200. Examples of other locations for batteries may include under a hood 215, behind seat 205, or at other locations within golf cart 200.

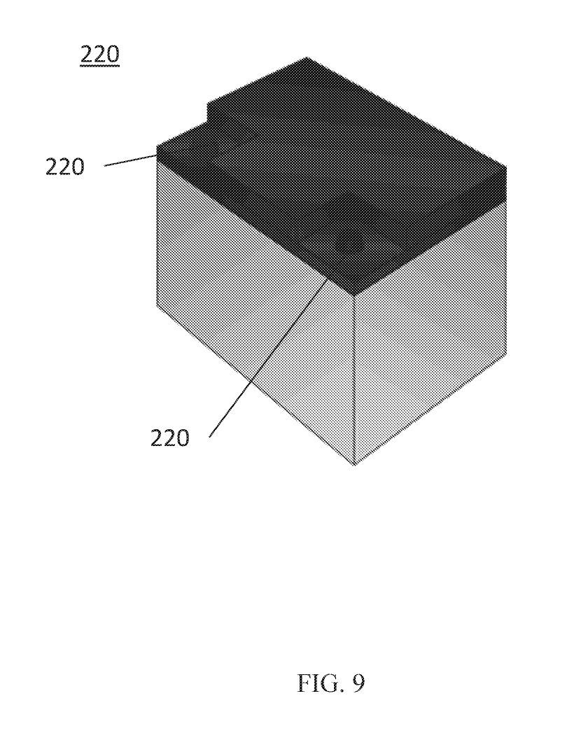

Referring to FIG. 9, an isometric view of a battery 220 according to embodiments of the present disclosure is shown. Battery 220 may include any type of conventional battery 220 that is configured to be used in motive devices, such as golf carts, boats, motorcycles or any other type of motive device as will be appreciated by those of ordinary skill in the art. Battery 220 includes a positive terminal 225, or cathode, and a negative terminal 230, anode. Electrolytes in battery 220 allow ions to move between the terminals, thereby allowing current to flow out of battery 220. Battery 220 may include primary, or single-use batteries, as well as secondary batteries. Primary batteries are typically used once and discarded because electrode materials disposed therein are irreversibly changed during discharge. In typical motive devices, such as golf carts, boats, and motorcycles, secondary batteries are used because they can be discharged and recharged multiple times. Secondary batteries may include lead-acid batteries, as well as lithium ion batteries. Motive devices typically use secondary batteries, and as such, provide a reliable power source for recharging portable electric devices through a battery clip connection (100 of FIG. 1).

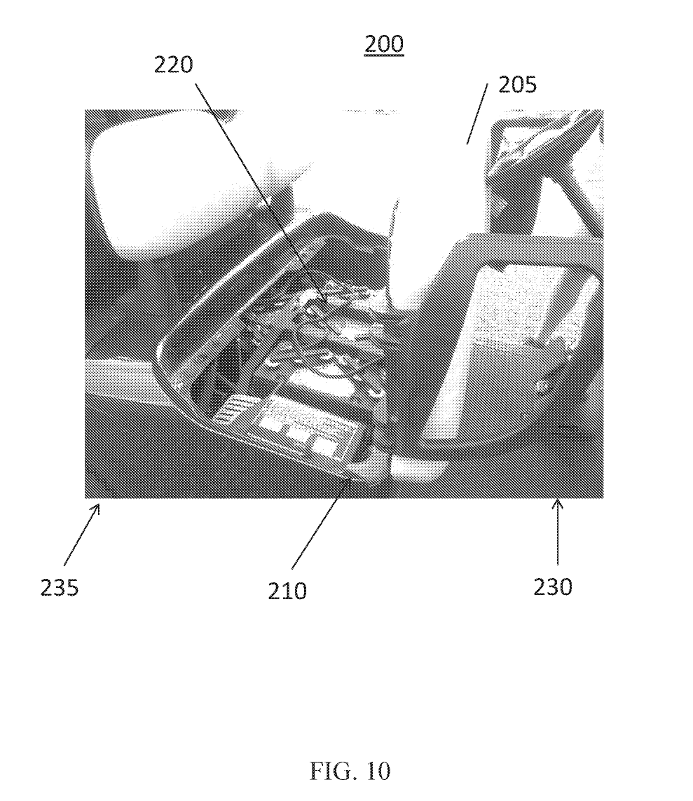

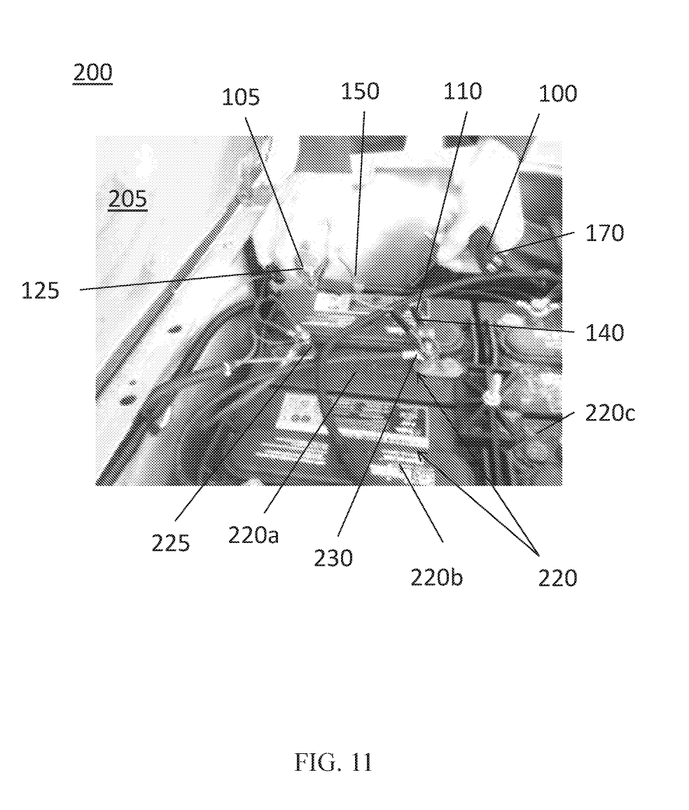

Referring to FIG. 10, an elevated side view of a golf cart battery compartment according to embodiments of the present disclosure is shown, Golf cart 200 includes a seat 205, a battery compartment 210, and one or more batteries 220. In this embodiment, golf cart 200 includes three batteries 220, however, in other embodiments, golf cart 200 may include one battery 220, two batteries 220, or more than three batteries 220, For example, in many modern golf carts 200, four batteries 220 are used. As illustrated, in order to access batteries 220, a user may lift seat 205, gaining access to battery compartment 210, and thus gaining access to batteries 220. While seat 205 is shown being lifted toward the front end 230 of golf cart 200, in other embodiments seat 205 may be lifted toward the distal end 235 of golf cart 200. Any configuration of seat 205 and battery compartment 210 may be used according to embodiments of the present invention, as long as a wire (250 of FIG. 1) can be run from batteries 220, out of battery compartment 210, and on to or out of seat 205.

In other embodiments, battery compartment 210 and thus batteries 205 may be located under a different seating configuration. For example, in a multiple seat golf cart 200, battery compartment 210 may be located under a secondary seat 205 located behind the primary seat 205. In such an embodiment, the battery clip connection (100 of FIG. 1) may be attached to a battery 220 that is located in a battery compartment 210 located under the secondary seat 205. In still other embodiments, the batteries 220 may be located in another location on golf cart 200, and as such, the battery clip connection (100 of FIG. 1) may be attached to batteries 220 and the wire (150 of FIG. 1) may be run from the other location to a location proximate seat 205.

Referring to FIG. 11, an elevated side view of installing a battery clip connection to a battery of a golf cart according to embodiments of the present disclosure is shown. In this embodiment, a golf cart 200 is shown having a seat 205, and a battery compartment 210. Multiple batteries 220 are disposed in battery compartment 210, Each battery 220 includes a positive terminal 225 and a negative terminal 230.

As discussed above, a battery clip connection 100 includes a first battery clip 105, a second battery clip 110, and a housing 170. Battery clip connection 100 also includes a wire 150 that connects first and second battery clips 105/110 to housing 170.

During installation, first battery clip 105 is attached to positive terminal 225 of battery 220 and second battery clip 110 is attached to negative terminal 230 of battery 220. The attachment of battery clips 105/1.10 to battery terminals 225/230 may occur by depressing a handle 125/140 of respective battery clips 105/110. By depressing handles 125/140, battery clips 105/110 are opened so that battery clips 105/110 may be fastened around battery terminals 225/230 in other embodiments, battery clips 105/110 may be opened and closed in alternative methods, such as screw-fit connections, whereby battery clip 105/110 may be opened and closed using a nut and bolt to secure the battery clips 105/110 to battery terminals 225/230.

In this embodiment, both battery clips 105/110 of battery clip connection 100 are shown attached to one battery 220. However, in alternate embodiments, first battery clip 105 may be attached to a first battery 220a, and second battery clip 110 may he attached to a second battery 220b. As such, the about of voltage applied to battery clip connection 100 may be increased. In such an embodiment that provides increased voltage to battery clip connection 100, more portable electric devices (not shown) may be attached to battery clip connection 100 and/or the rate of charge may be increased. In still other embodiments, a first battery clip 105 may be attached to a first battery 220a, and a second battery clip 110 may be attached to a third battery 220c. As the batteries 220 are run in series, the voltage applied to battery clip connection 100 may be further increased.

In still other embodiments, multiple battery clip connections 100 may be attached to one or more batteries 220. For example, in one embodiment, a first battery clip connection 100 may be attached to battery 200 and a second battery clip connection 100 may be attached to the same battery 200. In such an embodiment, whereby more than one battery clip connection 100 is attached to a single battery 200, both battery clip connections 100 may be supplied power from the same battery 220 source. In other embodiments, a first battery clip connection 100 may be attached to a first battery 220a and a second battery clip connection 100 may be attached to a second battery 220b. In such an embodiment, the first and second battery clip connections may receive power from different batteries 220. Those of ordinary skill in the art will appreciate that various other configurations of attaching battery clip connections 100 to batteries 220 are possible and are within the scope of the present disclosure.

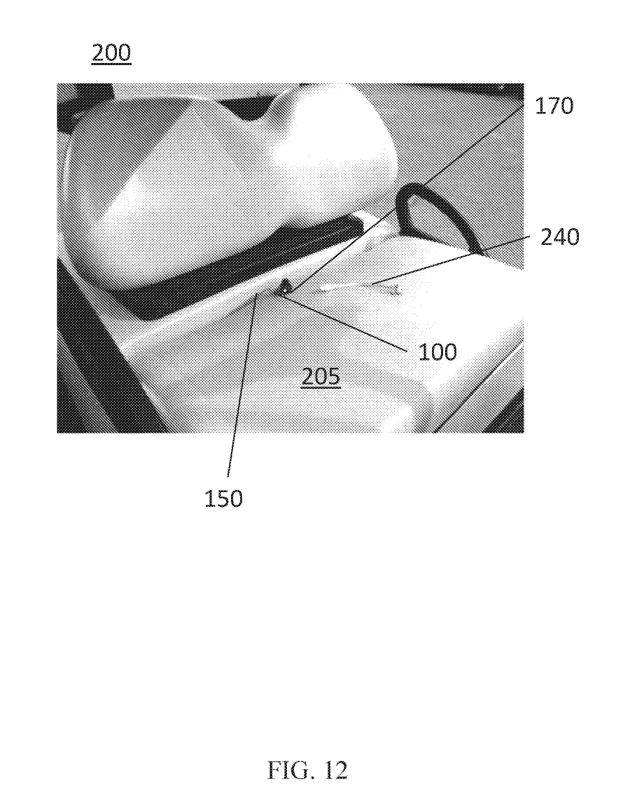

Referring to FIG. 12, an elevated front side view of a battery clip connection 100 installed in a golf cart according to embodiments of the present disclosure is shown. In this embodiment, a golf cart 200 includes a seat 205 and a battery clip connection 100 disposed on seat 205. Inside battery compartment (210 of FIG. 11), battery clip connection 100 is connected to one or more batteries (220 of FIG. 11). The wire 150 is then run under seat 205 and extends on top of seat 205, thereby allowing a user access to the housing 170 end of battery clip connection 100. In one embodiment, wire 150 is at least 24,0 inches in length, thereby allowing the housing 170 end of battery clip connection 100 to extend far enough out of seat 205 to allow a user access.

in addition to battery clip connection 200, an adapter 240 is shown. In one embodiment, adapter 240 may be used to attach one or more portable electric devices (not shown) to battery clip connection 100. The adapter may include various types of input and output terminals (not independently illustrated). For example, in an embodiment where the battery clip connection 100 includes one or more USB ports (not independently illustrated), adapter 240 may include one end that is configured to attach to a USB port and another end that is configured to attach to another type of connection. Examples of other types of connections include USB micro, USB mini, Firewire®, Lightning®, 30-pin, micro Samsung®, micro LG®, micro Pantech®, as well as various other proprietary connection. Those of ordinary skill in the art will appreciate that any type of connection capable of providing power to a portable electric device may be used according to embodiments of the present invention. In still other embodiments, rather than a USB connection on battery clip connection 100, a specific connection type may be used. For example, rather than use a USB connection on battery clip connection 100, a direct connection type may be used. Examples of direct connection types include, for example, USB micro, USB mini, Firewire®, Lightning®, 30-pin, micro Samsung®, micro LG®, micro Pantech®, as well as various other proprietary connection.

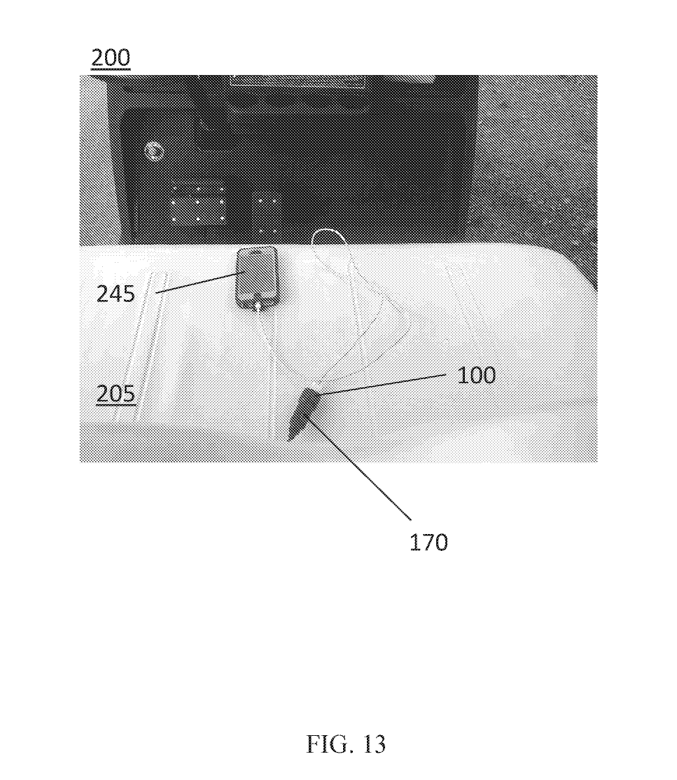

Referring to FIG. 13, atop view of a battery clip connection 100 installed in a golf cart and charging a cell phone according to embodiments of the present disclosure is shown. In this embodiment, a golf cart 200 having a seat 205 and a battery clip connection 100 is illustrated. As shown, battery clip connection 100 is shown run through seat 205 and a cell phone 245 is attached to battery clip connection 100 using an adapter 240. Battery clip connection 100 has a wire (150 of FIG. 1) of length sufficient to allow housing 170 end of battery clip connection 100 to extend out of the battery compartment (210 of FIG. 11). Because the wire is long enough to allow battery clip connection 100 to sit on seat 205, a user has access to battery clip connection 100 while a portable electric device, such as a cell phone 245 is attached to battery clip connection 100 while cell phone 245 is charging. Access to battery clip connection 100 during charging allows users to perform functions such as, for example, connecting additional devices to battery clip connection 100, removing cell phone 245 or other portable electric devices from battery clip connection 100, turning battery clip connection 100 on or off, or checking the charge of cell phone 245 or other portable electric devices that are attached to battery clip connection 100. Failure to provide a wire long enough to allow a user access to battery clip connection 100 while a portable electric device is attached thereto may negatively impact the ability of battery clip connection 100 to function because a user would not be able to access the portable electric device as it charges.

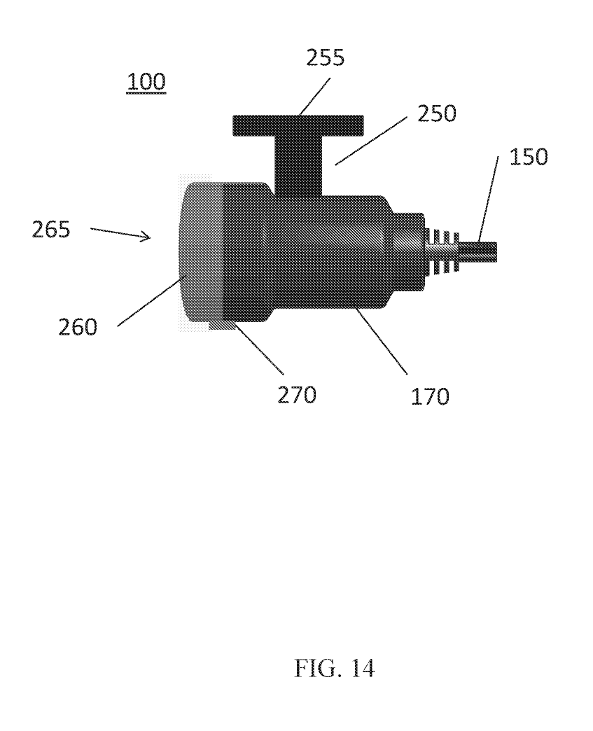

Referring to FIG. 14, a side view of a battery clip connection 100 having a mounting apparatus according to embodiments of the present disclosure is shown. In this embodiment, battery clip connection 100 is illustrated having a mounting apparatus 250. As illustrated, battery clip connection 100 includes a wire 150 and a housing 170. A mounting apparatus 250 is attached to housing 170, thereby allowing battery clip connection 100 to be attached to a motive device, such as a golf cart, boat, or motorcycle. In one embodiment, mounting apparatus 250 may include one or more magnets 255, thereby allowing mounting apparatus 250 to be secured directly to a motive device. In other embodiments, mounting apparatus 250 may provide for mechanical securement to a motive device through a mechanical clip such as, for example, cords, screws, brackets, nut-and-bolt securement, or other mechanical attachments as may be appreciated by those of skill in the art. In still other embodiment, mounting apparatus 250 may be attached to a motive device through temporary connections, such as, for example, hook and loop attachments such as Velcro®.

In addition to mounting apparatus 150, battery clip connection 100 also includes a water proof cap 260. Water proof cap 260 may prevent water or other environmental hazards from entering housing 170. Water proof caps 260 may fit around connection end 265 of housing 170 or may extend around substantially all of housing 170. Water proof cap 260 may be formed from various water resistant or water proof materials such as plastics, rubbers, and/or polymer composites. Water proof cap 260 may further be secured to housing 170 through a cap attachment 270. Cap attachment 270 may thereby prevent water proof cap 260 from becoming detached from housing 170 during use.

Methods according to embodiments of the present invention may allow for the charging of portable electric device through motive devices that typically do not allow portable electric devices to be charged. For example, many motive devices do not have charging ports, such as AC or DC connections, which readily allowing portable electric devices to be plugged into. In the instance of a golf cart, boat, motorcycle, or other motive device, a cover may initially be removed from the motive device. The cover may include a seat or other structured that provides access to a battery compartment. After removing the cover, a power source, such as a battery, may be disclosed to the user.

After the power source is disclosed, a first battery clip of a battery clip connection may be attached to a first post or terminal of the power source. A second battery clip of the battery clip connection may then be attached to a second post or terminal of the power source.

After the battery clip connection is connected to the power source, a wire of the battery clip connection may be extended through the cover of the motive device. In one embodiment, the wire may be extended out of a seat or battery compartment of the motive device. After the battery clip connection is extended out of the battery compartment and/or out of a seat the housing may be exposed. The housing may include a USB connection, or other connection that allows attachment of a portable electric device thereto. At this point, the battery clip connection is extended out of the battery compartment and is accessible to the user while the motive device is in use.

As the battery clip connection is accessible to the user during use of the motive device, a portable electric device may be connected to the USB connection, thereby providing power to the portable electric device. In one embodiment, the portable electric device may be a cell phone, however, in other embodiments, the portable electric device may include music playing devices, video capturing devices, computing devices, speakers, global positioning system devices, as well as various other devices. The portable electric devices may then be charged while the motive device is in use.

In some embodiments, the portable electric device may not be configured to connect directly to the USB connection. In such an embodiment, an adapter may be used to connect the portable electric device to the USB connection. In certain embodiments, more than one portable electric devices may be attached through use of one or more USB connections.

In certain embodiments, the battery clip connection may include functionality to automatically stop providing power to the portable electric device when the portable electric device is fully charged. In such an embodiment, when the portable electric device is substantially fully charged, an indicator light may illuminate on the battery clip connection, thereby informing the user that the portable electric device is fully charged and may be disconnected. In still other embodiments, an indicator light may illuminate during charging and turn off when the portable electric device is substantially fully charged.

In still other embodiments, the battery clip connection may terminate providing power to the portable electric device during an interruption condition. An interruption condition may include, for example, a power surge, an environmental condition, such as water interrupting the battery clip connection, a mechanical failure of one or more components of the battery clip connection or the power source, or any other condition that may adversely affect the battery clip connection, the power source, or the portable electric device.

Advantageously, embodiments of the present disclosure may allow for the charging of portable electric devices on motive device, such as golf carts, boats, and/or motorcycles.

Advantageously, embodiments of the present disclosure may also provide a mobile charging system that may be temporarily attached to a power source of a motive device, thereby allowing portable electric devices to be charged while the motive device is in use.

Advantageously, embodiments of the present disclosure may provide a power source attachment that allows for the charging of multiple portable electronic devices simultaneously.

Advantageously, embodiments of the present disclosure may provide a portable charging device that is configured to automatically stop charging a portable electric device when the portable electric device is substantially fully charged.

Advantageously, embodiments of the present disclosure may provide a portable charging device that is configured to automatically stop charging a portable electric device during an interruption condition that could adversely affect a battery clip connection, a power source, or a portable electric device.

Advantageously, embodiments of the present disclosure may provide a portable charging device that includes a substantially water proof cap and/or housing, thereby preventing environmental conditions, such as water, dust, or the like, from damaging the portable charging device, power source, or portable electric device.

Advantageously, embodiments of the present disclosure may provide a portable charging device that allows a user to access a portable electric device while the portable electric device is charging.

Advantageously, embodiments of the present disclosure may provide a portable charging device that has at least one switch that is configured to be accessed by the user to terminate the providing of power to a portable electric device.

Advantageously, embodiments of the present disclosure may provide a portable charging device that has at least one switch that is configured to stop providing power to a portable electric device when the portable electric device is fully charged.

Advantageously, embodiments of the present disclosure may provide a portable charging device that has a mounting apparatus that allows the portable charging device to be mounted on a motive device, such as a golf cart, a boat, or a motorcycle.

Advantageously, embodiments of the present disclosure may provide a battery clip connection having a wire that is of sufficient length to allow a connection end to extend to within reach of the user while a motive device is in operation.

While the present invention has been described with respect to the above-noted embodiments, those skilled in the art, having the benefit of this disclosure, will recognize that other embodiments may be devised that are within the scope of the invention as disclosed herein, Accordingly, the scope of the invention should be limited only by the appended claims.

What is claimed is:

1. A battery clip connection comprising:
a first battery clip;
a second battery clip;
a housing;
a USB connection disposed in the housing; and
a wire connecting the first battery clip and the second battery clip to the housing.

2. The battery clip connection of claim 1, further comprising a fuse disposed in the housing between the first and second battery clips and the USB connection.

3. The battery clip connection of claim 1, wherein the wire is at least 24.0 inches in length.

4. The battery clip connection of claim 1, further comprising a water proof cap disposed over the USB connection.

5. The battery clip connection of claim 1, further comprising an indicator light disposed on the housing.

6. The battery clip connection of claim 1, further comprising a mounting apparatus disposed on the housing.

7. The battery clip connection of claim 6, wherein the mounting apparatus comprises a magnet.

8. The battery clip connection of claim 6, wherein the mounting apparatus comprises a mechanical clip.

9. The battery clip connection of claim 1, further comprising a portable electric device connected to the USB connection.

10. The battery clip connection of claim 1, further comprising at least one switch in the housing.

11. The battery clip connection of claim 10, wherein the at least one switch is configured to automatically stop providing power to an portable electric device when the portable electric device is fully charged.

12. A method of charging a portable electric device, the method comprising:
removing a cover from a motive device and disclosing a power source;
connecting a first battery clip of a battery clip connection to a first post of a power source;
connecting a second battery clip of the battery clip connection to a second post of the power source;
extending a wire of the battery clip connection through the cover of the motive device;
exposing a housing comprising a USB connection outside the cover of the motive device;
attaching the portable electric device to the USB connection; and
providing power to the portable electric device.

13. The method of claim 12, wherein the portable electric device is a cell phone.

14. The method of claim 12, wherein the motive device is a golf cart.

15. The method of claim 12, wherein the motive device is a boat.

16. The method of claim 12, wherein the motive device is a motorcycle.

17. The method of claim 12, further comprising attaching a USB adapter between the USB connection and the portable electric device.

18. The method of claim 12, further comprising attaching a second portable electric device to a second USB connection.

19. The method of claim 12, further comprising automatically stopping the providing of power to the portable electric device when the portable electric device is fully charged.

20. The method of claim 12, further comprising automatically stopping the providing of power to the portable electric device during an interruption condition.
